(19) United States
(12) Patent Application Publication
(10) Pub. No.: US 2002/0130868 A1
(43) Pub. Date: Sep. 19, 2002

(54) Method and apparatus for providing financial instrument interface

(75) Inventor: Shane Smith, London (GB)

Correspondence Address: GREENBERG-TRAURIG, 1750 TYSONS BOULEVARD, 12TH FLOOR, MCLEAN, VA, 22102, US

(73) Assignee: Aston Guardian LImited, London (GB)

(21) Appl. No.: 09/994,902

(22) Filed: Nov. 28, 2001

Related U.S. Application Data
(60) Provisional application No. 60/253,546, filed on Nov. 28, 2000.
(60) Provisional application No. 60/293,041, filed on May 23, 2001.

(51) Int. Cl. G06T 11/20

(52) U.S. Cl. 345/440

(57) ABSTRACT

A graphical display system includes a server for receiving and processing financial instrument data from at least one financial data feed and a client computing device connected to the server for concurrently displaying to a user processed financial instrument data in graphical form, a multi-media streaming video presentation, and interactive communications associated with the financial instruments. Means may be provided for allowing analysts to dynamically enter comments and recommendations as text associated with the financial instrument data for view in the graphic presentation of financial data. Such text and data may be accessed simultaneously in real-time or near-real-time by multiple users.

This application claims the benefit of U.S. Provisional Patent Application Serial No. 60/253,546, filed Nov. 28, 2000, and U.S. Provisional Patent Application Serial No. 60/293,041 filed May 23, 2001, the entire disclosures of which are hereby incorporated by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to computer interfaces, and in particular to an interface for inputting and viewing information related to financial instruments using graphical presentations, multimedia and communication facilities integrated into one display.

### BACKGROUND OF THE INVENTION

In the trading and monitoring of financial instruments, such as stocks, the use of displays has typically been either overly simplistic, limited to the mere display of simple graphing of numerical values and charts, or greatly complex, providing the user multifaceted graphical displays and techniques to track the rise, fall and future predictions of the financial instruments. Thus, the amounts and types of simple information available to all but a handful of novice users is woefully incomplete, while complex information provided to all but a trader is convoluted to the point of being useless.

A need exists for a system which provides more types and additional relevant information to the majority of users through an interface.

Known graphics techniques are available for graphing and displaying data as curves. For example, U.S. Pat. No. 5,241,461 and European Patent No. EP 169703A2 describe methods using functional analysis to provide computerized displays for control systems such as for monitoring flow of coolant through a chamber. The behavior of the data for the subject coolant is graphically displayed, and various points are displayed related to the movement of the graph of the coolant, such as moving averages and inner and outer envelopes of the graph, thus allowing calculation of the probable future movement of the curve to determine the behavior of the subject coolant.

Heretofore, known graphic techniques designed for presentation to a mass, non-specialist market, have not been effectively employed in the field of financial instruments especially where the financial data is streamed on the Internet.

In addition, the presentation of financial information is typically limited solely to arrays of numbers, or limited solely to graphical charts illustrating such numbers and trends and changes in the numbers. Commentary from analysts, such as investment strategy and explanations of the displayed numbers or charts, is provided in the prior art by reports separate and independent from such arrays of numbers and charted numbers, and so user such as investors viewing such data must expend effort to properly link and associate such commentary with the actual numbers underlying the commentary, or alternatively such financial information must be reprinted in a separate report to be combined with such commentary.

Heretofore, prior art financial display systems and methods have not provided commentary linked with actual financial information presented graphically to a user.

In addition, such commentary is often generated by analysts long after the underlying financial information has become static, and accordingly stale for the purpose of rapid investor reaction to attain the best investments and trading actions.

Heretofore, prior art financial display systems and methods do not provide mechanisms for permitting analysts to dynamically generate such commentary for real-time or near-real-time display to and reaction by investors.

### SUMMARY OF THE INVENTION

In a preferred embodiment, the invention includes a graphical display system having a server for receiving and processing financial instrument data from at least one financial data feed and a client computing device connected to the server for concurrently displaying to a user processed financial instrument data in graphical form, a multi-media streaming video presentation, and interactive communications associated with the financial instruments. Means may be provided for allowing analysts to dynamically enter comments and recommendations as text for view in the graphic presentation of financial data. Such text and data may be accessed simultaneously in real-time or near-real-time by multiple users.

### BRIEF DESCRIPTION OF THE DRAWINGS

The foregoing and other features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates a schematic of the disclosed graphical display system;

FIG. 2 illustrates a screen displayed on the browsers of the external clients;

FIG. 3 illustrates different functional layers of the system;

FIG. 4 illustrates an application server;

FIG. 5 illustrates a data feed interface;

FIG. 6 illustrates connections of application servers to web servers;

FIGS. 7-8 illustrate configurations and software processes of the data feed interface;

FIG. 9 illustrates a schematic of an alternative embodiment of the disclosed graphical display system of FIG. 1; and

FIGS. 10-15 illustrate screens displaying financial information to users and to analysts, with input windows in selected screens for inputting textual commentary associated with selected financial information.

### DETAILED DESCRIPTION OF THE PREFERRED EMBODIMENTS

Reference will now be made in detail to the preferred embodiments of the present invention, examples of which are illustrated in the accompanying drawings.

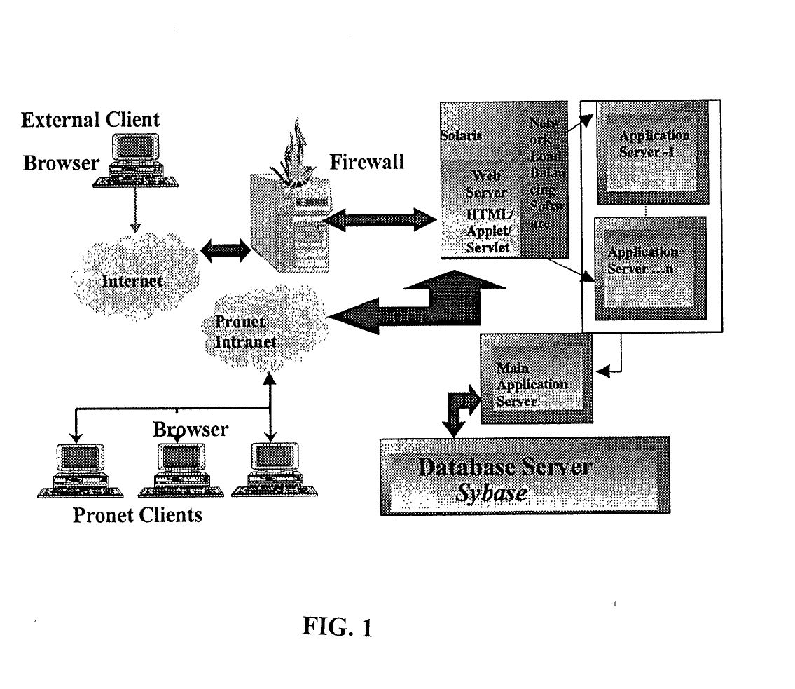

As shown in FIG. 1, the disclosed system and method present data and information using multi-media to a plurality of users. In particular, for a given financial instrument, the same view is provided to an entire global audience. It is this shared view which provides the platform for communication. Another feature of the disclosed system and method is that the financial data and analysis is “streamed” in the same way as audio and/or visual data. A third feature is that the service is genuinely global: global financial exchange coverage, global equities coverage, and global delivery. The fourth feature is that the system and method are based upon an intuitive, visual presentation, such that value can be gained without resorting to language which, despite the prevalence of English, might not be shared by the entire audience, whereas the visual aspects and cues are shared by global audiences, for example, in the financial services industry.

The example embodiment of FIG. 1 illustrates a web-based architecture allowing external clients to access and display data through the Internet from a plurality of subscribing clients, called PRONET clients.

One aim of this architecture is to prescribe a component-based and layered approach for application development. Through the subscribing clients, the system prescribes the industry-wide standards to be adopted for applications, and recommends standard procedures and products taking into account the latest technologies and their evolution. The goal is also to leverage the latest technologies and products, and adopt them to requirements.

In the architecture of FIG. 1, external clients can access the system through the Internet, where as the internal users can use the intranet to access the application. The HTML pages are available in the client machine on request, and the web server is responsible for taking the user inputs and passing them to the presentation layer, applets and servlets that reside in the application server. The servlets are also capable of interfacing with emulators and/or wrappers of a legacy system.

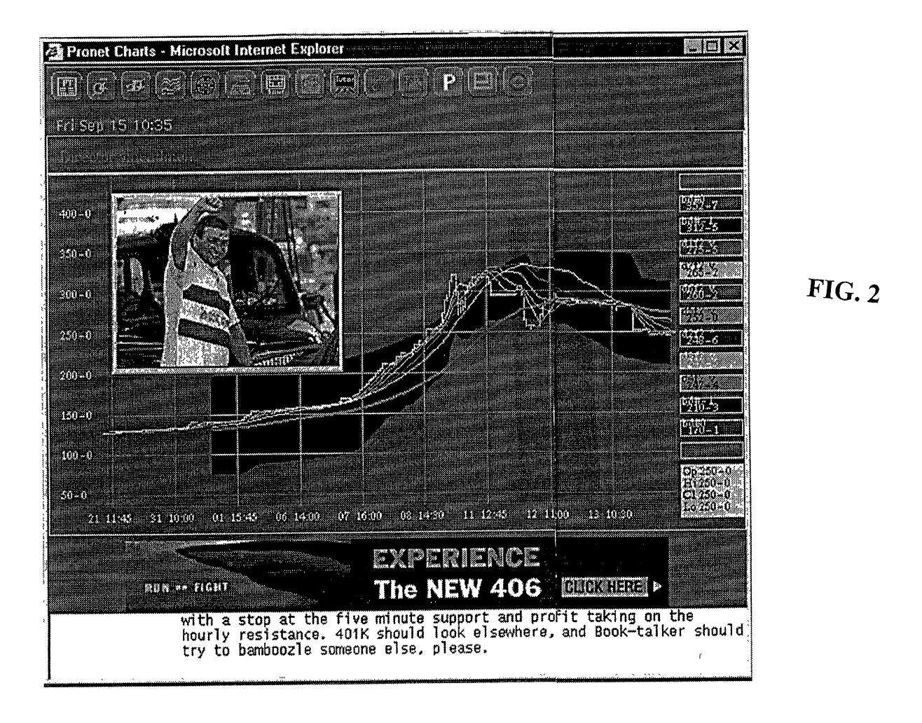

FIG. 2 illustrates a screen displayed on the browsers of the external clients and provided by the system of FIG. 1. The graphic shows a region of the screen or canvas for displaying streaming data, which is analyzed in real-time, and so giving the user the ability to examine financial information ranging over durations from very short term (minute by minute) time periods to very long term (month by month) time periods. The analysis may be performed by known data calculation and display techniques, using data tracking, moving averages, and windowing and projections of movements of data, such as the systems and methods described in U.S. Pat. No. 5,241,461 and European Patent No. EP 169703A2, which are incorporated herein by reference.

The screen in FIG. 2 makes it possible for a user, such as a stock trader, to pick, view, and track any available financial instrument, such as liquid stock from any stock exchange. For each stock, there is a chat room provided, for example, at the bottom of the screen below the canvas and, optionally below advertisements such as banner ads, which may be a streaming video banner space between the chat panel and the visual panel. The chat room is specific to the displayed and graphic financial instrument, allowing the user to communicate with any other trader around the world regarding the displayed financial instrument, with the benefit of the visual aid of the graph for facilitating decision-making. Within the canvas there is also a space for streaming video presentation, such as for analyst meeting coverage, annual general meetings (AGMs) for stockholders, ads etc.

Referring to a “Chart of the Day” feature on a website accessed by a user, upon actuation by the user, the screen in FIG. 2 is generated and an applet delivers through the user's browser for streaming quotes with analysis which updates itself at least every minute, either delayed or real-time. The analysis is based on known data analysis techniques described, for example, in U.S. Pat. No. 5,241,461 and European Patent No. EP 169703A2, as well as other known financial analysis methods, with different analysis techniques employed on the basis of the techniques' strong performance and wide applicability across asset classes. The system and method are capable of providing the analysis, for example, for 64,000 global equities. For each of these equities, there is an associated chat room. As described herein, the chat panel for the equity is displayed below the chart canvas in FIG. 2, and between the chart and the chat panel, there is optionally displayed a streaming video banner for advertising, for example, a product or service of the company analyzed in the chart.

As described herein, a TV-type panel is displayed within the chart canvas, using standard technologies such as Realmedia. Thus, the system and method provide a widely-available, standardized (generic/uniform) environment for multi-market, shared visualization (display/presentation), analysis and communication in real-time, as well as a communication facility, where a chat room is defined with reference to its associated financial instrument, such as a t-bond room, an “AOL” room, a “CISCO” room, etc.

Streaming video content such as ads, coverage of AGM's, etc., are also embedded within the canvas of the graphic itself. In addition, multimedia tools are provided to access and teach the audience how to use the service. The analytical method itself has been selected on the basis that it is intuitive to use, effective, and can be applied across asset classes and time-frames with equally high performance. Thus the disclosed system and method provides a unique insight into the risk engaged prior to executing the trade.

### Specific Utilities of the User Interface

The utility menu of user interface in FIG. 2 has the following important features and commands: Instruments, Intervals, Horizon, Range, Roam Values, Print Image, Tour, Trade, Tutor, Drawing, and System Administration.

### Instruments

Using the Instruments feature, all markets currently selected are listed here. The prices are color coded to identify the last tick update. If the price is marked in red, the price was down, but if it's blue, then the price was up. If it is white, the price was unchanged and if it is gray the market was closed.

### Intervals

The interval bar and number of intervals on view are defined here by user selections, such as by the use of pull down menus and/or input windows. The time bar and the number of observations can be selected to re-draw the charts. The user can save the last chosen format as his/her profile, and upon the next log-on, the system draws charts in the saved format.

### Horizon

The Horizon facility provides the user the benefit of viewing a chart in an organized view, which unclutters the chart by turning on/off each individual director. Also the length or horizon of wave cycle under scrutiny can be altered by changing a identifying number, such as a fib number.

### Range

The Range setting identifies the support and resistance levels. The range of each individual chart can be amended depending upon the number of intervals and the time frame selected.

### Roam Values

The detailed historical data can be viewed by moving the pointer across the chart. Bad data fixes can also be achieved here.

### Print Image

Using the print image feature, an image can be printed to store the record of the market status.

### Tour

A Tour contains a series of charts chosen in an order which is regularly or typically used. One Tour can be created for each instrument. In other embodiments, a selection of different markets cannot have a tour.

### Trade

Trade functionality provides the user with the visual presentation of risk/reward profile.

### Tutor

The Tutor function provides a simulated trading situation whereby a user can go back in time and watch the market evolve.

### Drawing

The Drawing function permits display of text, arrows and lines on a chart. The drawings are specific to the user.

### System Administration

System Administration tools provide the following facilities:

User Maintenance: setting user's defaults like inner and outer band, timescale, observations etc.;

Bad Database Repair: a database for a certain period can be extracted, repaired and inserted again to fix the bad data;

Instrument Activity Set Up: sets up for each market its opening time, closing time, its future month, current month, rollover date, rollover status, decimal places, market symbols, etc.; and

Calendar Setup: sets up the calendar for different markets.

### Implementation

The disclosed system and method may be implemented in software and capability of handling, for example, at least 10,000 financial instruments, and scalable to, for example, 65,000 financial instruments.

The front end of the external client are, for example, JAVA-based thin client and/or X-windows based clients. In one embodiment, the front end may be downloadable for the web client by having a relatively small file size.

Once the software for the front end is downloaded or received, and then installed on the external client of each user, the screens may be re-sizable, and the software is very secure, capable of accurately handling about 65,000 instruments in the database, such as the database server of FIG. 1. In one example, the database server supports financial instruments on foreign exchanges (FOREX) having, for example, 115 available financial instruments.

The system is adapted to address, for example, about 1,000 concurrent users, with a user management module for security, and the ability to traverse through the firewall.

The system and its data analysis techniques may also perform gap analysis for instances of missed data, for detailed reporting and tracking. Indications of disruptions in markets, such as local holidays, may also be incorporated into the system, and the system also accommodates markets with multiple trading sessions, and includes the display of multiple graphs.

Other features include the ability to handle a user base of, for example, about 25,000 concurrent users, with multiple time zones and trading and tracking over such multiple time zones being incorporated into the system. The system is also capability of handling bulk requests for user permissions, for example, for administrators to permit access by institutions with multiple users. Known billing systems may also be incorporated.

Additional features supported by the system may include the ability to give context sensitive helps and assistance to users, as well as to handle and promptly report bad prices. Printing capabilities are also provided. Furthermore, a user profile database may be generated and updated to capture more information to facilitate accurate processing by a billing system. Such captured user information may include: frequency of visit of a user; difference in time and activities between his/her visits; how long has s/he been logging into the system; how many strikes has s/he done and which stocks has s/he been looking at; and what are the sites the user accessing just before visiting the system access website, and which are the sites s/he is going to after visiting the system access site.

Other features including support of full or entire sets of financial instruments, such as about 500,000 instruments, and increasing user bases such as, for example, 50,000-250,000 users. Sophisticated data filters such as filtering for issues including bad pricing or stock splits. Optionally, the system may integrate the TV style viewer and video ad hooks for advertising and revenue collection, and the system accommodates delayed data feeds.

The screen and the overall graphic user interface (GUI) providing the screen may include roaming cursor facilities and a real zoom facility, and may be adapted to accommodate multi-session markets. In addition, auto-rolling may be supported based on open interest of accessing users, and automated replacement of rolled markets in interest list may be provided.

In alternative embodiments, a chat server may be included in the system shown in FIG. 1, preferably a chat server dedicated for each instrument to support multiple financial instruments and multiple users per instrument to encourage users to remain logged on and accessing the chat rooms/panels for each instrument.

Moreover, the system is also able to display stocks and other financial instruments in more than one selected currency, and the system is also WAP-enabled for mobile and/or remote access.

### System Configurations and Architectures

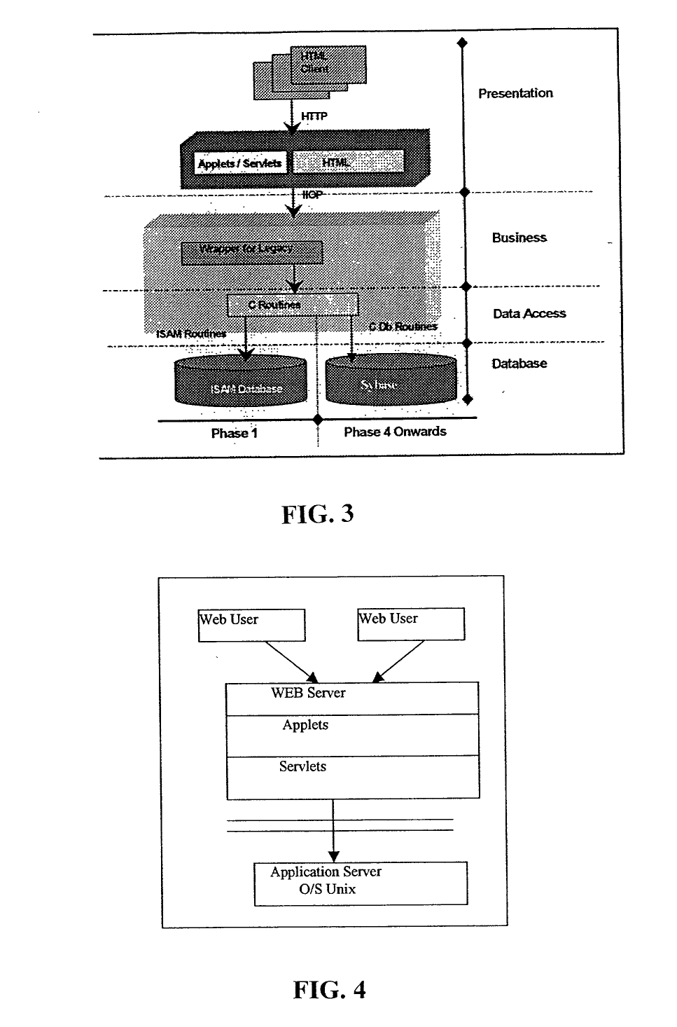

As shown in FIG. 3, different layers of the system of FIG. 1 are identified as encapsulating specific functionality. The Presentation layer is responsible for interacting with the user by displaying different forms and obtaining the inputs, as well as handling the customization and related actions as per security requirements. The Business Object layer consists of methods executing application specific logic/processing. The Data Access layer consists of methods that interface with the databases and perform specific functions on data, and also maps relational data to objects. The Database layer consists of the actual database and deals with storage/placement of data.

The components in the presentation layer may be deployed as Java Applets, Servlets and/or HTML pages. The business object layer consists of wrappers for legacy system and C-Routines, and serves as an interface between the Servlets and C Routines, for use with the underlying data access layer to access and use persistent data. The data access layer components may be implemented in a Sybase server to implement C-DB Routines and/or a C-ISAM routine. The database layer may include a Sybase-type database to permit access from the data access layer through C-DB Routines.

In an example embodiment of the system resource requirements, the following components may be used: the operating system may be Solaris 2.7 on a SPARC platform; the hardware may be a Sun Micro Systems Web Server, and the application server may be on Solaris 2.7 provided on a SPARC platform. The database may be a Sybase implementation from Sybase with a C-DB Library, and the database may be migrated from ISAM files to Sybase files. An available developer tool may be Visual Cafe from Symantec, and network load balancing software may be supported on Solaris 2.7, such as Load Balancing Software (LBS) from Solflower. Graph Generating tools may be NetChart from Visual Mining Inc., and a CORBA compiler may be Orbix from IONA.

As to the hardware infrastructure of system, the database may be as described herein with the capacity to be increased to accommodate the number of instruments to 500,000 and the number of users to 250,000. The database may move to a distributed environment because the projected size of database may be 300 GB.

With the introduction of the network load balancing software, the corresponding hardware for the web server may be provided to support such load balancing software, and multiple application servers run parallel on the Sun SPARC Server hardware. The network components may include existing TCP/IP-based network devices of sufficient number and capacity to meet the operating requirements described herein.

Example implementations of the system may includes: for the hardware/OS/Network, the front-end is a personal computer (PC) running eXceed as a web client or any typical web client without any limitations. For the application servers, central server, database server, and web server, the Solaris 2.7 software may be used on SPARC servers, with multiple web servers having network load balancing software managing the servers. The LAN topology may be an Ethernet network and/or a TCP/IP-based system.

In one implementation, the software for the user interface may include XVIEW, Guide, and Perl, including Java (applets), Java Servlets, Wrapper software for Legacy systems, and graph generating tools such as Jchart, and Espress Chart. The data analysis may use analytics logic for supporting C, shared memories, sockets, ISAM files, and Lex-yacc files, and the C-ISAM link may be replaced by a C-DB library for SYBASE applications.

Data feed and handling routines may provide a satellite link for S&P based data, a 64 kbps link for Reuters-based data, and the Reuters SSL4 software for real time data handling. The database may include ISAM files and/or Sybase files.

The front end of the system for the external client displays may be totally replaced by a Java-based environment immediately, and real-time data fees may be from at least two sources, such as Reuters and Standard and Poors (S&P). The Reuters data may be handled by third party software called SSL4 before being passed on to the system's price server. Also S&P data comes directly to the system through, for example, a serial port after reaching the network from satellite and being split through a splitter modem, and TCP/IP may be used as the network protocol of the system.

### Additional Enhancements

The user interface is built in Xview and launched in the web through a combination of HTML-Perl/CGI scripts which delivers the goods with the use of an X-emulator. Alternatively, the proposed interface is written in a combination of Java-servlets-applets. Some graph generating tools such as Jchart, Espress Chart, Netchart, etc. may also be used.

The user interface may be integrated with the application server, and may also include an instrument configuration module for letting the user select his/her own set of financial instruments to look at from the given list of instruments. The user interface may be re-sizable, for example, using a Java based user interface; and the user interface itself may be downloadable to the external client of the user, for example, using a Java-based client. Such user interface software may be configured to operate using 18 MB of memory, and/or to be a thin client as in case of standard web client.

The user interface records and tracks the IP address of the client giving the request. In other embodiments, user interface may be prevented from requesting any other details at all of the users trying to access the site, to permit the software of the system to be provided and supported as freeware.

The system may be accessed using an HTML-based web page to launch the product irrespective of the fact of whether the user is accessing the system from behind a firewall or not. In a Java-based version of the system software, the IP address of the client is noted by a lbproxy routine, and then the application is launched to that IP address, in a similar manner as getting the DISPLAY of xterm while the process is running actually in the server.

A Java-based interface may also draw graphs locally, so there is no dependency on the IP address for providing the graphic functionality. The normal dependencies are provided by the proxy server/firewall of the user's network. The user interface may also support a roaming cursor facility, a display of multiple graphs, and a real zoom facility to be able to maximize a part of the work on the screen.

For the application server supporting a user base of, for example, 1,000 users, the application server and the GraphServer maintain the slots for these many users in a shared memory to maintain user profiles. In addition, the application server may also sense that no update is coming for a particular market and so to provide an alert to the user in an audio ring or a visual message, as well as to report missed data for a market in detail. A data file is maintained for local holidays and is built into the system to report such events.

A schematic of the system with the application server is shown in FIG. 4, in which the load of the application server is distributed on the end-users web clients in one embodiment, while in other embodiments, the user interface actually runs as a process in the application server itself and also draws the graphs in the application server itself. In an implementation using a Java-based user interface, the graphs and the interface are all executed in the client machines.

In some implementations, the system may support many hundreds of users because the users run the user interface in their PCs only as applets, as opposed to implementations in which the user interface itself runs in the server only and a client gets the display set to his/her PC.

In such distributed implementations, maintenance and enhancements may be effected easier because of modular nature of the architecture, and any functionality may be readily added to the applet-servlet duplet. Remote support is easily possible because of the fact that the whole system is on the public Internet and there is no need of having a high speed connectivity between the remote support center and production site. In addition, capital costs are lower because of the remote support center.

Additional implementations may include authentications of users before being able to access the product; for example, each user has a password for accessing the website to access the system. The application serer may also keep logs of user accesses, which is maintained typically in a user profile data file, which apart from the above information also includes the user's password and the financial instrument configuration setup details.

In addition to inclusion of a billing module, the system may also include a software module for segregating user groups and also permitting only specific user groups to access the system. The groups may be maintained in terms of geographical location, firm or institution confines, etc.

The available markets supported by the application servers may include EQUITIES and Future markets in addition to the existing FOREX market. Modules are also provided to store the information about the delay factor of the different sources and then when the data arrives, the data is captured and stored only after doing the necessary adjustments to the date stamp of the data in the database.

In supporting auto-rolling based on open interest, the moment when the number of open interests increases one of the future contracts, auto-rolling occurs, and automated replacement of rolled markets in interest list is enacted.

### the Data Feed Interface

The system includes an interface between the S&P and Reuters data feed and the users, which may be, for example, the IntuTechnics Technical Trade Station (ITTS). In one implementation, the system is written using a C/ISAM DB library, and resides on Sun Solaris hardware running SunOS Unix operating system. The user interface may be based on the eXceed software, and the user accesses the application via the World Wide Web of the Internet, which in turn launches an independent front end in eXceed.

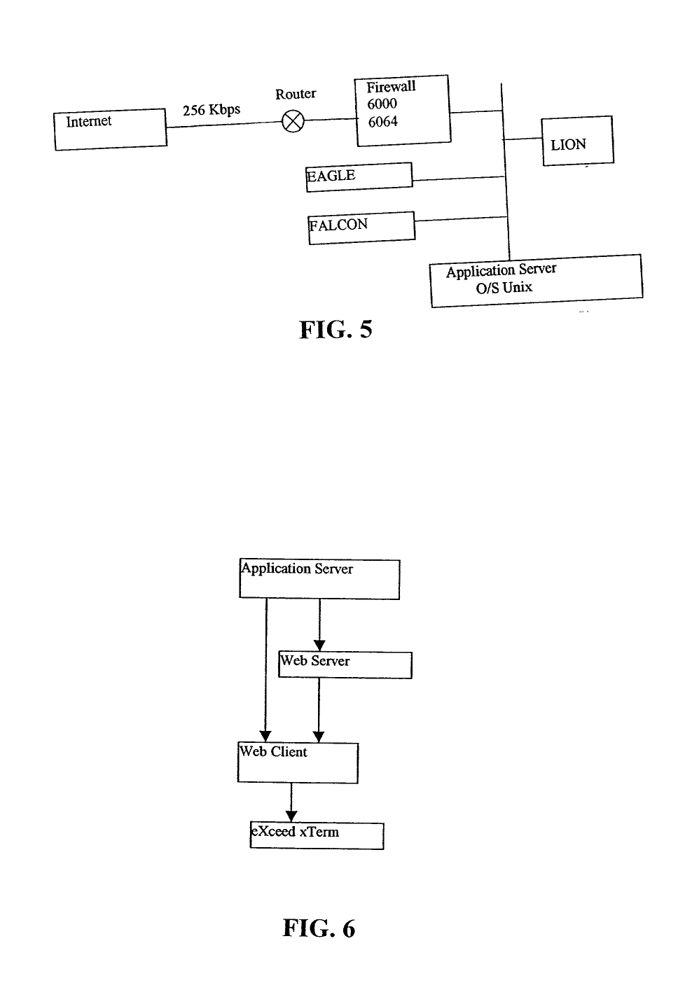

Referring to FIG. 5, the ITTS runs on SUN Solaris 2.7 on SPARC hardware, and has an architecture including a single Unix server and three web servers labeled, for example, LION, EAGLE, and FALCON. The user logs into the application via the web, such as a main web server LION, which in turn directs the request to another web server, by sending the client to the EAGLE web server and sending trials of data to the FALCON web server for data analysis to generate the charts. The request is then processed in the Unix Server and the data and charts are sent to the user. Referring to FIG. 6, each user in the user community connects to the application servers via the World Wide Web, and all PCs have eXceed installed to function as external clients as in FIG. 1.

The system is written using one or more of C/Lex/Yacc/ISAM DB library on a Unix operating system. The user interface may be one of Motif/X-Windows/eXceed.

The ITTS application captures the real-time data feed from S&P and Reuters via, for example, a satellite link. A number of server processes read the data, store the data in the database, and make it available to the user in the form of charts as in FIG. 2. These server processes interact among each other via shared memory segments, socket connections and ioctl. These processes also make the real-time data available to the user. The updating in data is viewed by the user on the front-end which uses eXceed. The user logs into the application via the World Wide Web, which launches the application in eXceed and leaves the control over to it. The ITTS software architecture is shown in FIG. 6. The PCs of the users/customers function as the external clients as in FIG. 1, which are used as graphical display terminals for the applications on the application servers.

The customer PCs are connected to the application server via the World Wide Web, and the customer PCs launch eXceed.

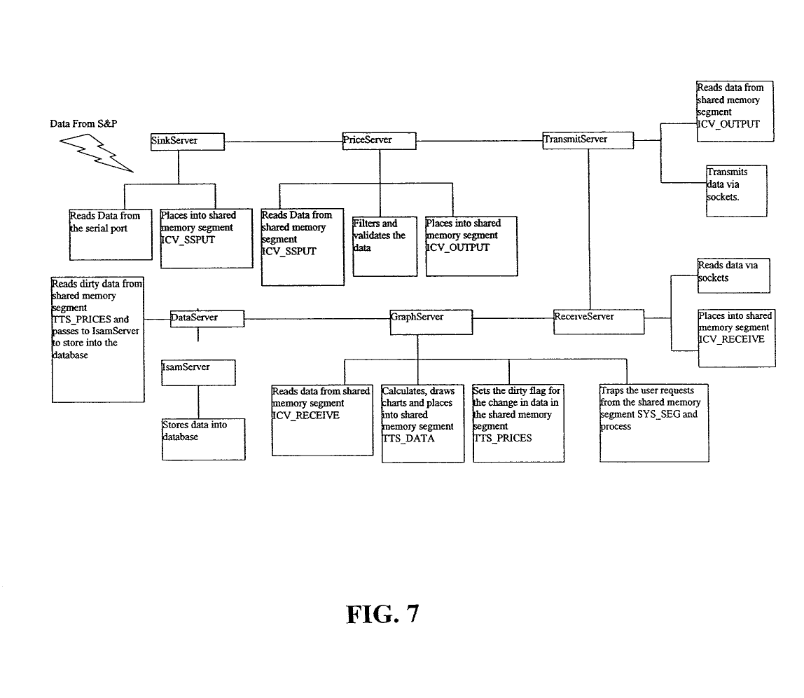

In one embodiment, shown in FIG. 7, the ITTS system uses software code which is heavily dependent on Unix system calls, ioctl and inter process communications. Real-time data is collected from Reuters and S&P, data from S&P is processed by SinkServer and PriceServer, and data from Reuters is processed by the SSL4 Server. GraphServer handles user requests, draws the charts and also changes the data of any financial instrument. DataServer and IsamServer take the responsibility of storing the data into the database. WatchServer monitors all the processes and starts/stops the server processes as and when required. Front end programs such as tts_base, tts_start, and tts_manager provide the user with a visual format of the data.

TradeSmith is another form of presentation of the data specifically designed for the users. The following Tables 1 and 2 summarize the overall statistics of ITTS lines of code according to application area/type:

TABLE 1

| | Approximate number of lines | |
|---|---|---|
| | of code in KLOC (including | |
| Type | comments and blank lines) | Remarks |
| Front End | 63 | Programs include tts_start, |
| screens | | tts_manager, tts_base, |
| | | WatchServer and |
| | | tts_control |
| Business | 17 | Includes Servers and |
| Logic | | SSL4Servers |
| Common | 9 | Commonly used files such as |
| Files | | Ccp, aimslib, etc. |
| Web | 4 | |
| programs | | |
| Total | 93 | |

TABLE 2
Number of Files

| | | | | | HTML, | | |
|---|---|---|---|---|---|---|---|
| | | | | | PERL, | Oth- | |
| Application Area | C | H | COM | CPP | JAVA | ers | Total |
| Web Server | 0 | 1 | 0 | 0 | 25 | 1 | 27 |
| SSL4Server | 0 | 8 | 0 | 7 | 0 | 1 | 16 |
| Application Server | 25 | 4 | 35 | 0 | 0 | 3 | 67 |
| Common Files | 11 | 21 | 0 | 0 | 0 | 2 | 34 |
| Database Access Layer | 88 | 8 | 0 | 0 | 0 | 3 | 99 |
| Front End | 45 | 57 | 0 | 0 | 0 | 74 | 176 |
| Total | 169 | 99 | 35 | 7 | 25 | 84 | |
| Total Number of Files | | | | | | | 419 |

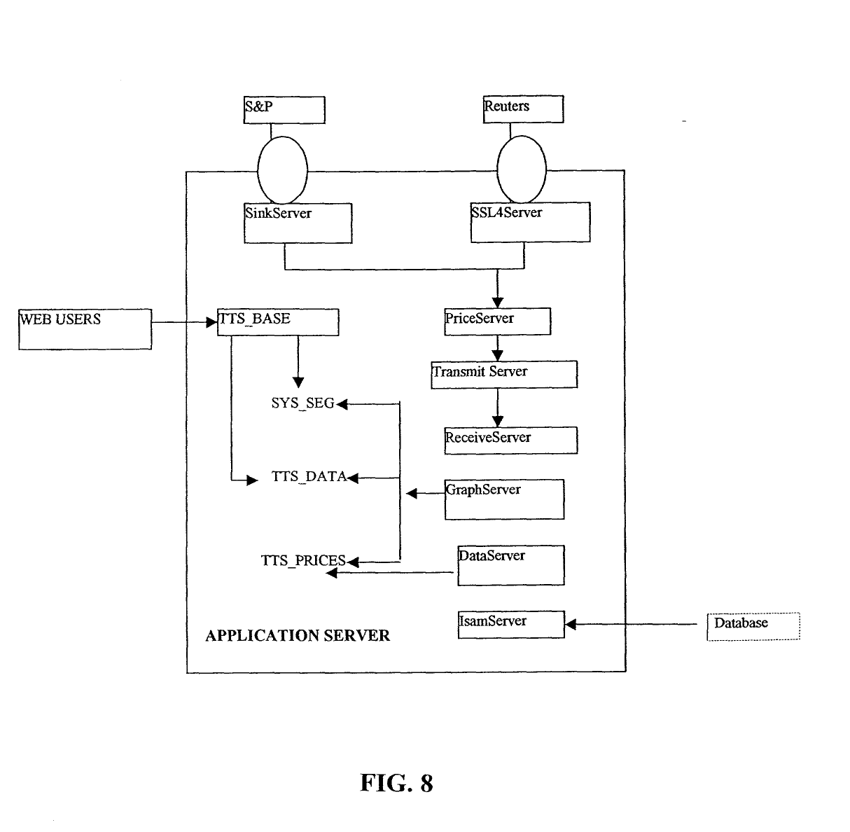

Referring to FIGS. 7-8, the ITTS code may be broadly classified into the following components:

SinkServer reads the data from the serial ports and places into a shared memory segment.

PriceServer reads the data from the shared memory segment, filters it and puts the validated data into another shared memory segment.

TransmitServer reads the data from the shared memory segment and transmits it via sockets.

ReceiveServer reads the data via sockets and places into another memory segment.

GraphServer reads the data from the shared memory segment. It reads out the data on instruments in a shared memory segment, handles user requests, and calculates, refreshes, creates the charts and places into another shared memory segment. The change in data is notified by setting a dirty flag against the corresponding instrument. It checks if there are any requests from user and processes those.

DataServer and IsamServer work in conjunction with each other. These two servers save, delete, update data in the database.

WatchServer monitors the processes and starts/stops them.

As shown in the following Table 3, users place a request for a specific chart which is sensed by the GraphServer. If the chart does not exist in the shared memory segment then the data is pooled from the database, and after mathematical calculations is put into the shared memory segment. From this shared memory segment the chart is thrown to the user. Simultaneously, the incoming real time data for various instruments is also updated into the shared memory segment. The DataServer and IsamServer keep a constant check on this shared memory segment and store the data into the database. The details of the database is listed below:

TABLE 3

| Database file | Functionality |
|---|---|
| alert.isam | Stores the alerts |
| alert_messages.isam | Stores the alert messages. |
| annotation.isam | Stores the annotations. |
| calendar.isam | Stores the market specific opening time, closing time etc. |
| cross.isam | Stores the information for crossing the two markets. |
| defset.isam | Stores the user specific defaults. The defaults are |
| | corresponding to the timeframe and chart. |
| drawing.isam | Stores the drawings as done by the user on a chart and saved. |
| empty.isam | It is usually empty but is used as a backup during the cleanup |
| | process. |
| errors.isam | Stores the error messages. |
| filter.isam | Stores the rules for filter mechanism. |
| icv_dbase[00 - | Stores the data as fed by Reuters and S&P. |
| 31].isam | |
| Icv_select.isam | Stores the information about all the instruments. Data fed |
| | from Reuters/S&P for any instrument, which is not stored in |
| | this file is rejected and is not processed. |
| inst.isam | Stores the instruments for each of the users |
| p3params.isam | This database file is specific to the TradeSmith and stores the |
| | information regarding TradeSmith. |
| password.isam | Stores all the user passwords. |
| print.isam | Stores the print as saved by the user. |
| rollover.isam | Stores the rollover info. |
| series.isam | Stores the server names and the corresponding Fibonacci |
| | series. |
| symbology.isam | Stores for each of the data from the Reuters the record for |
| | Ticker Symbol. |
| tour.isam | Stores the info about the tour as saved by the user. |
| trade.isam | Stores the information about trade. |

Each market is mapped to a defined Hex number as a unique identifier. However if two markets happen to be defined by the same Hex number, then the Hex number combined with the symbol for month and year is unique. Corresponding to this unique number, it is decided that to which icv_dbaseXX.isam file the data is to be saved.

### Existing X-Based GUI Functions

As described herein, the system uses known software processes, such as UNIX-based commands and routines, to provide major functionalities of the existing GUI Functions and processes.

The tts_base process uses the following programs: tts_base_own.c, tts_system.c, tts_link.c, isam.c, ism.c, ccp.c, pcp.c, tts_base_ui.c, tts_print_{—own.c, a}_substr.c, a_newseg.c, a_setnam.c, and tts_draw.c. The tts_base process operates using the environment variables: TTS_PRICE, FILTER_MECHANISM, TTS_FEED_MONITOR, DISPLAY, TTS_TIME_FORMAT, TTS_EXCEED, TTS_SITE, TTSHOME, TSLOGDIR, TTS_STARTEK, and TTS_SELECT.

The tts_base process functions as a front-end program to perform the following steps: opens, populates and sorts the data from the instrument static data file into a structure; sets the time zone; initializes Xview; processes any command line arguments; checks the authkey and report; initializes the user interface components; loads User, user's configuration etc.; attaches to the shared memory segment SYS_SEG.; attaches to the price segment PCP_SEG.; attaches to the shared memory segment TTS_DATA.; obtains data from the memory, if already loaded into the memory; sets up chart constants; loads tour for the used logged in; saves the parameters and sets the timers, with the timer polling the server and refreshes the screen from the shared memory segments; checks if the data is continuously fed. If not, it notifies the user; runs and stops alerts; on exit, it prompts to save or not to save the settings or cancel; on selection of save, user definition is stored in the database; the tour is also saved for the user logged in; and logs out of the server, that is it cleans up the data relevant to the user in the shared memory segment SYS_SEG.

The tts_start process uses the tts_start_own.c program and handles user sign-on and invocation of the system manager program tts_manager or tts_base. The tts_star process performs the following steps: initializes all the user interface components; gets the license details and report accordingly; sets up the fonts and loads them in; gets the button names from the password file; finally it turns the control over to XView by invoking the xv_main_loop function; calls back functions including one for the invocation of the tts_manager after the verification of the system managers' password;

can launch tts_base program on verification of the users' password; and the tts_start program dies.

The tts_manager process uses the following programs: tts_manager_own.c, a_setnam.c, tts_patch_own.c, tts_cal_own.c, tts_usetup_own.c, tts_set_pass own.c, tts_psetup_own.c, tts_modem_own.c, tts_instr_own.c, tts_fdisk_own.c, and tts_bjob_own.c. The tts_manager process performs the administrator's work by the following steps: exits if the tts_manager is already running; initializes Xview; initializes user interface components; sets up systems manager password; maintains system user; repair bad database; sets up instrument activities; and setups calendar.

The SinkServer process uses system calls: getenv, shmget, shmctl, shmat,

gethostbyname, socket, connect, putBuffer, bind, getsockname, recvfrom, ioctl, lockf, lseek, memset, umask, nice, htons, and mlockall. The SinkServer process uses the following programs: icv_kr_modem.c, a_setnam.c, a_newseg.c, a_lockmgr.c, and putbuffer.c; and uses the following environment variables: TTS_FEED_LINE, TTS_FEED_SPEED, TTS_FEED_VENDOR, ICV_HOME, TTS_HSN_SERVER,

TTS_HSN_TCP_PORT, TTS_HSN_UDP_PORT, and TTS_HSN_PROTOCOL. The SinkServer process connects to the socket and reads the incoming real time data, puts the real-time data into a shared memory segment, locks the memory, exits if there is a SinkServer already running, and sets the signal handling functions. If the TTS_FEED_VENDOR=HSN then it reads the environment variables for HSN, and opens the shared memory segment ICV_SPPUT. Depending upon the TTS_HSN_PROTOCOL (TCP or UDP), the process opens, connects and receives data from the socket and writes into the shared memory segment ICV_SPPUT. If the TTS FEED_VENDOR=SP then it opens the shared memory segment ICV_SPPUT, verifies and sets the baud rate, opens the device based on TTS_FEED_LINE, and reads data from the device and puts into the shared memory ICV_SPPUT. If TTS_FEED_VENDOR=“KR” then the process opens the shared memory segment KR_INP, verifies and sets the baud rate, opens the device based on TTS_FEED_LINE, reads data from the device, and puts into the shared memory KR_INP.

The PriceServer process uses the calls: mlockall, nice, lockf, lseek, memset, umask, iscntrl, socket, connect, sent, and recv; and uses the programs: icv_decode.c, icv_l.l, icv_y.y, a_setnam.c, a_lockmgr.c, a_newseg.c, convertprice.c, putbuffer.c, connectserver.c, and isam.c, with the following environment variables: ICV_SSPUT, ICV_INPUT, ICV_OUTPUT, ICV_AUX, and TTS_SELECT. The PriceServer process reads the data from the shared memory segment as put by the SinkServer, filters the data, puts into another shared memory segment ICV_OUTPUT, exits if the PriceServer is already running, sets the signal handling functions, and opens shared memory segments:

ICV_INPUT for Reuters, ICV_SPPUT for S&P, ICV_AUX for AUX, and ICV_OUTPUT to keep the processed data. The PriceServer process opens, sorts and stores the data file as specified by TTS_SELECT into a structure; sets the time zone; reads the shared memory segment ICV_INPUT, ICV_SPPUT, ICV_AUX for the incoming real time data; reads the instrument data file via the sockets, and populates into a structure. It then parses the data, validates through the list of instruments, and stores into the shared memory segment ICV_OUTPUT.

The TransmitServer process uses the calls mlockall, socket, accept, bind, send, and getsockopt; and uses the programs icv_transmit.c, a_newseg.c, createserver.c, getbuffer.c. The TransmitServer process reads real-time data from ICV_OUTPUT and transmits the data through socket, exits if the Transmit Server is already running, sets the signal handling functions, attaches to the shared memory segment ICV_OUTPUT, creates a socket, and the data in ICV_OUTPUT is transmitted through the socket created.

The ReceiveServer process uses the calls socket, connect, and mlockall, and uses the programs icv_receive.c, connectserver.c, and a_newseg.c. The ReceiveServer process reads real-time data from ICV_OUTPUT and transmits the data through socket, exits if the Transmit Server is already running, sets the signal handling functions, attaches to the shared memory segment ICV_OUTPUT, creates a socket, and the data in ICV_OUTPUT is transmitted through the socket created.

The GraphServer process uses the calls getenv, shmget, shmctl, shmat, gethostbyname, socket, connect, PutBuffer, Bind, getsockname, recvfrom, ioctl, lockf, Iseek, memset, umask, nice, htons, and mlockall. The GraphServer process uses the programs icv_ddist,c, isam.c, ccp.c, cross.c, and GetDBfile.c, with the environment variables: TTS_SELECT and TTS_ROLLOVER. The GraphServer process reads from the shared memory segment ICV_RECEIVE. The maximum number of charts is the first command line argument. If not passed, then the maximum number of charts GraphServer can handle is a predetermined number, such as ten. The process then exits if the GraphServer process is already running, sets the signal handling functions, attaches/opens the shared memory segment ICV_RECEIVE, TTS_DATA, and TTS_PRICES, attaches/opens and initializes the shared memory segment SYS_SEG, opens, reads and sorts the data in the instrument data file and populates into a structure via socket connections. The process then copies the content of the structure into the shared memory segment TTS_PRICES, and executes init_cross in cross.c. If it resides on the server then automatic rollover is instantiated, sets an infinite loop, and checks if any request from any client has been trapped. If there are any requests then the process determines if the request is to remove a chart, and the chart is removed from the shared memory TTS_DATA. If the request is to create a chart then the data is read from the database, then the chart is recalculated. If the request is to refresh a chart then the data, if resident in memory, is refreshed from the memory else the data is pooled out from the database and the chart is recalculated.

The process then checks if the data in shared memory segment ICV_RECEIVE is changed. If so, then the process updates the prices in the shared memory segment TTS_PRICES, updates the charts in the shared memory segment TTS_DATA, and sets a flag in the shared memory segment SYS_SEG, so that the graph is refreshed second time on refresh.

The DataServer process calls getenv, shmget, shmctl, shmat, gethostbyname, socket, connect, PutBuffer, Bind, getsockname, recvfrom, ioctl, lockf, seek, memset, umask, nice, htons, and mlockall. The process uses the programs: icv_dbase.c, a_setnam.c, and isam.c, and the environment variables: TTS_DBASE and TTS_SELECT. The DataServer process reads the shared memory segment TTS_PRICES for the data, which has been updated and passes on to the IsamServer to store into the database, and exits if the DataServer is already running. The process sets the signal handling functions, opens all the database files, attaches to the shared memory segment TTS_PRICES, opens, sorts and populates the data from the static instrument data file into a structure, and checks for all the instruments, if for any of these the data is changed; that is, for any of the instruments the dirty flag is set to true. A socket is opened, connected and the data is sent to the socket for the request for updating, deletion or insertion, and the dirty flag is set to false.

The IsamServer uses the programs: server.c, isam.c, ism.c, and createserver.c and processes the requests for data updating, deletion or insertion into the database. The process exits if the IsamServer is already running, creates a socket, which receives requests as sent by the DataServer, and depending upon the nature of request like deletion, updating, insertion, selection, opening a database, closing a database, getting the next record etc, the corresponding action is performed.

The WatchServer process uses the programs: tts_watch.c a_setnam.c checkenv.c, and the environment variables: TTS_LOGVERS, TTS_CONFIG, SERVER_NAME, and PORT_NUMBER. The WatchServer process initiates the SinkServer, PriceServer, TransmitServer, RecieveServer, GraphServer, DataServer, and KRServer processes, exists if the WatchServer process is already running, exits if any of the environmental variables is not defined, and sets the signal handling functions such that the TTSLOGVERS is analyzed to determine history length of log files in the TTSLOGDIR directory. The process then gets the process identification number of all Server processes and store them in the array ppids. The process then checks the config file for server and options, and it first obtains the fall pathname of the config.tts file by obtaining the TTS_CONFIG environmental variable and then opens the file for reading only. The process obtains the server name and port number sets the environmental variables SERVER_NAME and PORT_NUMBER. If the host name is the same as the one found in the config.tts file then it looks at the rest of the current line to see which processes need to be started. If the environmental variable PORT_NUMBER is not set, then the process exits immediately, and starts to listen on that socket and process any orders that come through from tts_control. The process analyzes the commands that are received from the socket, and when the process receives a valid command, the process executes the command. If it is not valid then the ServerSocket is closed. If the command is valid, the process looks to see whether a process needs to be stopped or restarted, and does the same.

The start (tts_control) process calls the nice call, and uses the programs: tts_control.c and connectserver.c. The process uses the environment variable TTS_CONFIG, and operates by starting one or all of the server processes: IsamServer, SinkServer, PriceServer, TransmitServer, ReceiveServer, GraphServer, DataServer, KRServer, and FistServer. The start (tts_control) process raises the priority of the process by calling nice(-5), checks the argument list to ensure that they are valid, and if not, the process exits. The process opens and analyses the config.tts file, and the start_job function is called with the appropriate arguments which are obtained from the config.tts file and tts_control command line. The start_job routine first connects to the serversocket created by the WatchServer, and the correct target hostname must be passed to the ConnectServer function at this point. Furthermore the start_job routine makes a function call to recv to see what message comes back through the socket, that is, the result from WatchServer.

### Alternative Embodiments

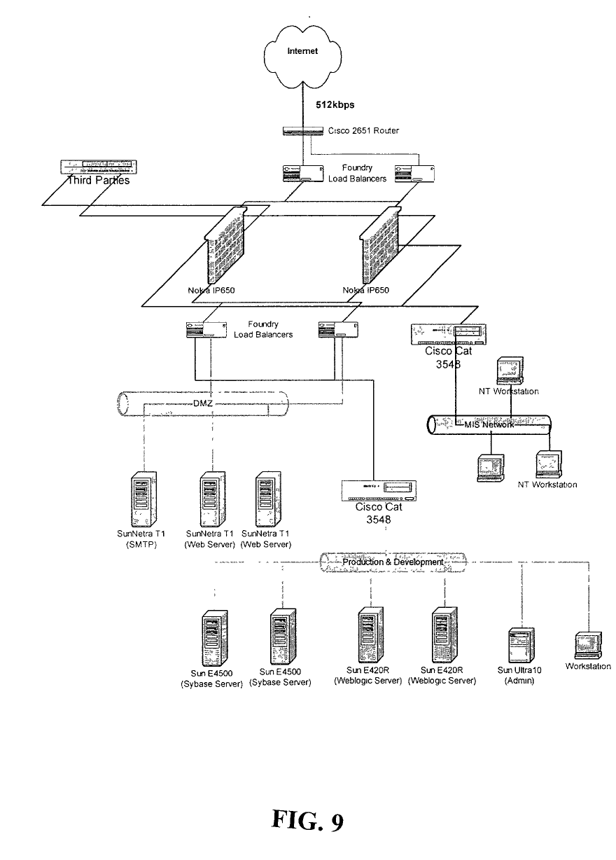

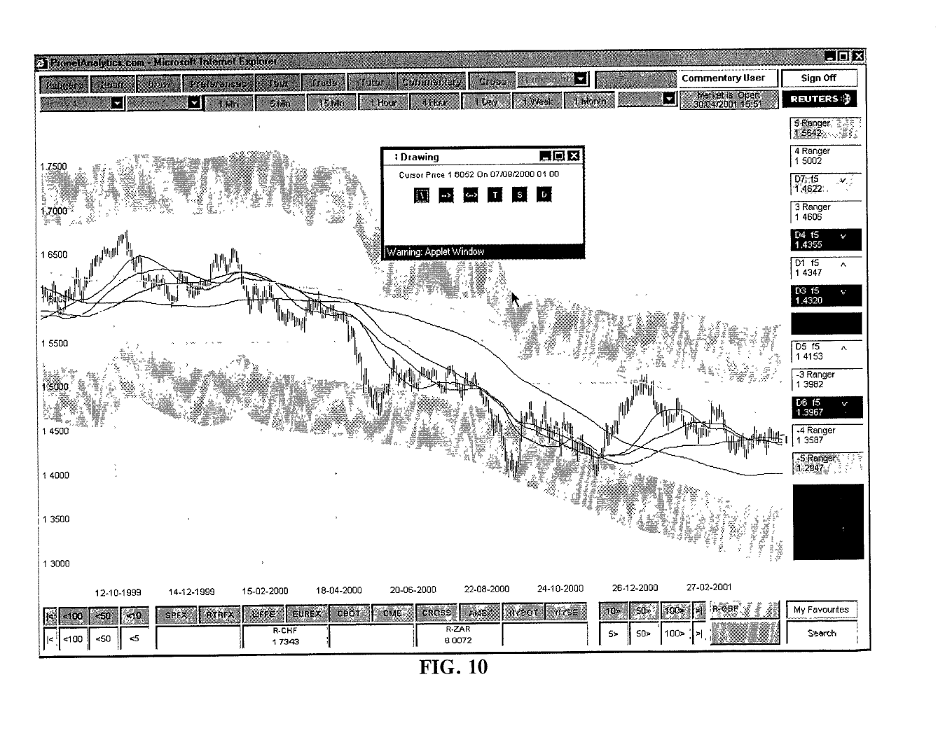

In an alternative embodiment, the system and method disclosed in FIGS. 1-8 may be used to provide the financial information displayed to users such as investors, and including dynamically inputted textual information for annotations, such as commentary and analysis, dynamically created by and input from analysts using annotation input mechanisms and methods, as described herein in connection with FIGS. 9-15.

FIG. 9 illustrates an example implementation of the system of FIG. 1, in which the various networked components of FIG. 9 are incorporated into and/or included in the various components of FIG. 1. For example, as shown in FIGS. 1 and 9, the system includes at least one firewall, which may be Nokia IP650 network components, for interfacing with the Internet through a load balancer and a router, such as a Foundry load balancer and a Cisco 2651 Router, respectively, as in FIG. 9, to communicate through the Internet to a browser of an external client, as in FIG. 1. In addition, third parties may connect through the firewall and/or bypass the firewall to allow such third parties such as browsers of Pronet clients to communicate with the Pronet Intranet, and thence to the Pronet components shown in the front end and back end of the disclosed system shown in FIGS. 1 and 9.

In an example embodiment shown in FIGS. 1 and 9, the front end includes Solaris-based network components for executing web servers and HTML/Applet servlets, as well as network load balancing software; for example, the front end may include Foundry load balancers and Cisco Cat 3548 components to interface with backend buses and networks, such as a “Demilitarized Zone” (DMZ), a management information system (MIS), and a product-and-development sub-system.

The DMZ provides providing secure connections to SunNetra-based systems using T1 -based communications to provide SMTP services and web servers for the disclosed financial information display system and method. The MIS connects to at least one NT workstation for use by network managers and administrators to monitor and control the operation of the disclosed system and method to maintain sufficient network resources for providing such financial information to users through their browsers of Pronet clients and external clients.

The production-and-development sub-system establishes connections to Sun E4500 components providing Sybase database servers, for example, to receive, store, and provide the financial information for diverse financial instruments, as well as to store any associated textual commentaries and annotations by analysts, as described herein. In addition, Sun E420R components provide WebLogic servers running as application serves, including a main application server, to implement the disclosed financial information display system and method, as described herein.

The production-and-development sub-system is also connected to a Sun Ultra 10 server for administrative functions and operations, and to at least one workstation for use by administrators as well as analysts, as described herein, to permit the dynamic modification of the disclosed dynamic financial information displays to include textual commentary and annotations to be stored in the Sybase and/or the Weblogic servers.

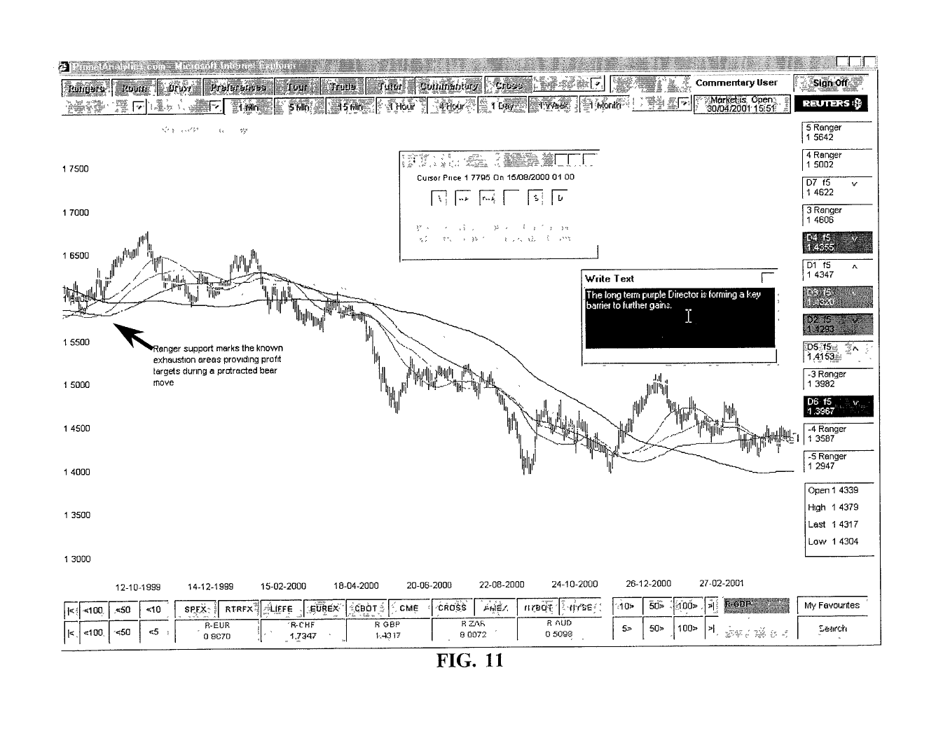

Referring to FIG. 10, financial data is displayed on the screen of an analyst using a workstation of the production-and-development sub-system, in a manner identical to the display of such financial data on the browsers of clients/users as shown in FIG. 2. In fact, in a preferred embodiment, analysts access and view the same financial data, with the graphical representations of financial values, such as stock prices and moving averages, presented to analysts simultaneously with other users. Alternatively, the analysts may access and view the same financial data but with a predetermined lead time ahead of users, such that analysts have a window of time to annotate the financial data with textual commentary before users may view such financial data. Accordingly, users are provided with the most up-to-date financial data simultaneously with the most up-to-date analyst commentary.

In one embodiment, the disclosed system and method employ human analysts who annotate the financial data as described herein with reference to FIGS. 11-15. Alternatively, automated computer systems, such as software-based agents, may be used to automatically detect preset conditions in the financial data, such as a low stock price. The disclosed system and method may perform such automatic detection using known pattern recognition techniques, such as neural networks, expert systems, and/or other artificial intelligence methods, and the preset conditions may be specified and stored in the back-end servers by analysts and/or administrators through the workstations of the system shown in FIG. 9.

Referring to FIGS. 9-10, in a preferred embodiment, the analyst views the financial data provided to users, but the analysts has the additional functionality, not provided to the users, to annotate the financial data through the screen in FIG. 10. The annotation may be incorporated into the chart or grid on the screen, for example, in one embodiment, using graphic user interface (GUI) functions such as point-and-click to activate input windows, such as the drawing window in FIG. 10 or the text input window, for example, in FIG. 11. The annotation may be a predetermined color, such as white, for use on darker backgrounds. Alternatively, the annotation may be color-reversed relative to any existing background color. In a further embodiment, the annotation may change colors, such as blink, in order to alert users, such as investors, of the dynamically changing situation of the displayed financial information.

In other alternative embodiments, instead of an input window, the GUI may generate a small input field or even an underline in which, for example, a blinking rectangular cursor may appear, such that the analyst may input the commentary by typing on a keyboard such that the GUI displays the typed text in the input field or over the underline. Alternatively, the workstation of the analyst may employ a touch-screen display, with the GUI of the analyst responding to finger or stylus contact by the analyst on the touch-screen display to activate such input windows, input fields, or input underlines.

The analyst screens shown in FIGS. 10-15 are capable of being actuated by the analyst at any point on the graph and grid lines including the chart of financial data, and so the screen actuation techniques described herein, as well as other GUI and/or screen actuation techniques known in the art, may be used for permitting an analyst to select any point at or substantially adjacent to a financial data point for entering the textual commentary. Alternatively, the analyst may select the point of annotation as being on the axis of the graph/chart; for example, the time and date indices on the horizontal axis, or price, volume, rate, and/or ratio indices on the vertical axis, as shown in FIG. 10.

In an example embodiment, the financial data and the graph/chart shown in FIGS. 2 and 10 may be dynamically updated, with a predetermined window of time being displayed from, for example, left-to-right on the screens of FIGS. 2 and 10, with older data moving leftward, newer data introduced on the right side of the graph, and the oldest data at the leftmost side of the graph being removed and/or “dropping off” the graph/chart. The removed financial data may be stored for later access by analysts and users, or may be redisplayed by resizing the chart and/or expanding the time window to a longer time duration in the past, or to a different time granularity, such as a week-long, monthly, or multi-monthly chart instead of a daily chart.

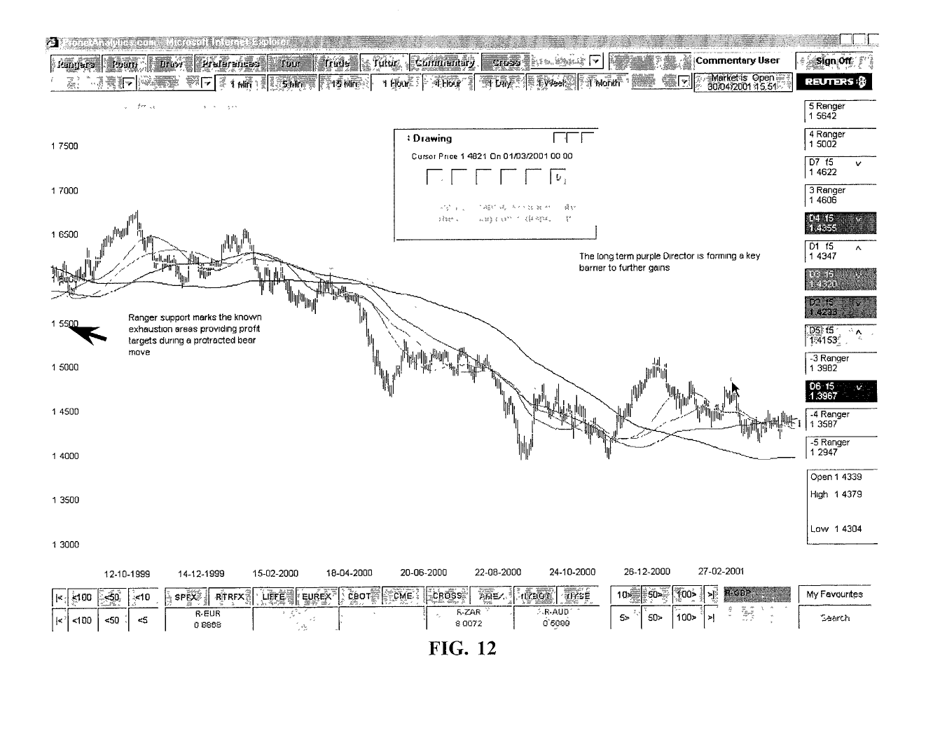

In the preferred embodiment of the dynamically updated annotation system and method described herein, for analyst-inputted textual annotations associated with selected financial data and/or a specified axis point on the chart, each annotation remains associated with the selected data or specified point, even as the older data “drops off” the chart as time passes. For example, as shown in FIGS. 11-12, an analyst may have previously entered a first annotation such as “Ranger support marks the known exhaustion areas providing profit targets during a protracted bear move.”, with the first commentary indexed to the financial data at, for example, the date around Oct. 11, 1999 (11-10-1999), as shown in FIGS. 11-12. In a preferred embodiment, the annotations are visually linked to the selected point in the chart by arrows, shown in FIGS. 11-12, extending from the annotation to the selected point. Although arrows and annotations are not shown in the user screen in FIG. 2, the arrows from annotation to chart point shown in FIGS. 11-12 of the analyst screens are, after input by the analyst, simultaneously generated and displayed to the users viewing such financial data with associated annotations. That is, after the analyst inputs the annotations, the charts and annotations are simultaneously displayed on each of FIGS. 2 and 11-12 to analyst and user alike.

As described herein, the text input windows provided to the analyst to facilitate text input, for example in FIG. 11, are not shown to users. The display of the text input windows are unique features of the GUI and the workstation used by the analyst, and so with respect to inputting annotations, the display of the typical users, such as investors and money managers, and the display of analysts are distinct.

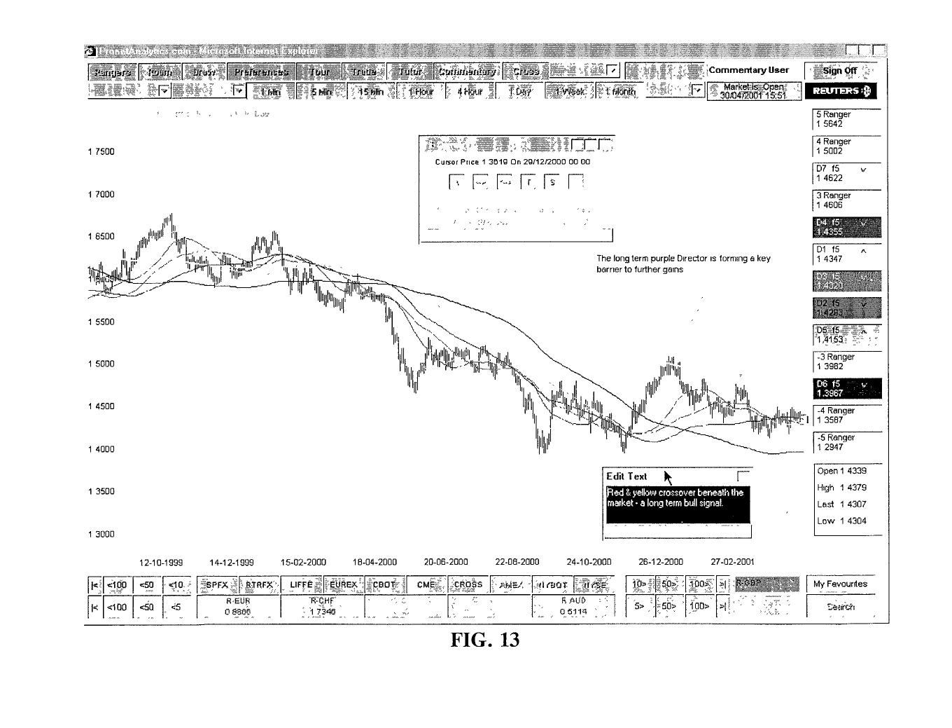

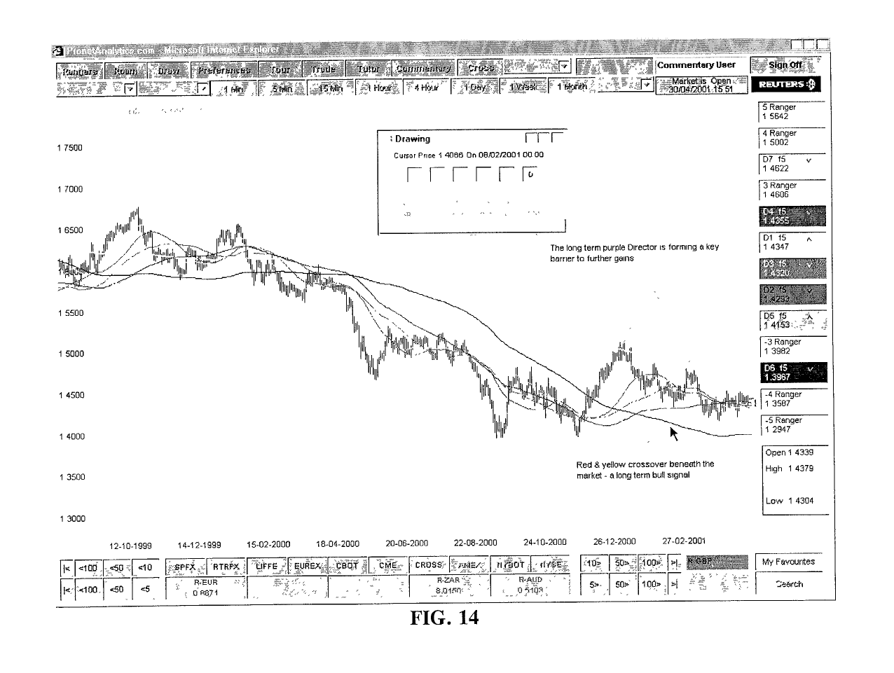

As the chart is updated with new financial data as in FIGS. 13-14, and with the date index 11-10-1999 extending leftward off the chart, such that the leftmost date index becomes 12-10-1999, the first commentary is removed from the screen; that is, the text of the first commentary appears to scroll leftward out of the viewable chart window of the predetermined time duration of, for example, about 15 months from 12-10-1999 to 27-02-2001.

In a preferred embodiment, to generate such annotations, an analyst viewing a screen, such as the screen in FIG. 10, positions via a mouse, interfacing with the GUI, the cursor, such as the arrow in FIG. 10, to a selected location in the chart or grid lines, which may utilize a palette of colors for displaying the financial data. The location selected by the analyst is where the annotation is to be located, for example, to be associated with one of the colored bands enveloping the financial data plots, such as a purple envelope or “Director” line. Once the cursor is selectively positioned by the analyst at the desired location, the analyst activates, through the GUI, an input window by, for example, double-clicking a mouse button of the mouse of the analyst's workstation.

In response to such activation commands, the disclosed system and method generate an annotation input window, as shown in FIG. 11, which may be an applet window generated through the GUI and implemented by a browser executed on the analyst's workstation. The disclosed system and method position the generated annotation in the region of the screen approximately where the inputted annotation is to be displayed on the chart. Through other input devices, such as a keyboard, the analyst then inputs the text of the annotation, for example, “The long term purple Director is forming a key barrier to further gains.”

After reviewing and finalizing the text, the analyst activates a finalization command through the keyboard or mouse, for example, by pressing the ENTER key on the keyboard, and the disclosed system and method respond by removing the input window, by storing the inputted text in an annotation database in one of the Sybase servers and/or the Weblogic servers, and by inserting into the chart a displayed text message including the inputted text as an annotation, as shown in FIG. 12, at or substantially near the location on the chart or grid selected by the analyst. In addition, the disclosed system and method may also display a line or arrow, as shown in FIGS. 11-12, from the annotation to the selected location on the chart or grid. In an alternative embodiment, the disclosed system and method may provide a line drawing function, using GUI-based painting and line-drawing techniques, such as those software functions used in “MICROSOFT PAINT” or computer-aided design (CAD) software, to permit the analyst to generate the line or arrow and to link the ends of the line or arrow such that one end is positioned adjacent to the annotation and to the selected location, respectively, using the cursor near one end of the line such as shown in FIG. 12.

As shown in FIG. 13, the analyst may generate multiple and/or branched lines or arrows from the annotation to multiple points in the chart, to associate such multiple points with a common annotation, such as the peaks in the financial data in FIGS. 13-14, with such peaks being indicative of and illustrating the limiting pressures of the purple envelope on gains, measured on the vertical axis in the example chart shown in FIG. 13.

In addition, multiple annotations may be displayed on the screen. For example, as shown in FIG. 13, an analyst using an activated input window applet is positioning an annotation approximately where red lines and yellow lines cross, with such lines representing trend lines, moving averages, expected values, values adjusted for inflation or currency, and/or other data or meta-data associated with the displayed financial data.

In the new text being entered in the window applet by an analyst in FIG. 13, the analyst is commenting that “Red & yellow crossover beneath the market—a long term bull signal.” After finalization, the analyst saves the annotation for storage by the disclosed system and method, as described herein, and the new annotation is displayed as in FIG. 14 with previously inputted and currently displayed annotations as in FIGS. 13-14.

In the example embodiment, the “Red & yellow crossover . . . ” annotation may not have a line or arrow to the crossover, at the discretion of the analyst, but instead may appear to “float” on the screen near the crossover, while the “The long term purple . . . ” annotation has one or more lines to the selected points in the chart. The analyst decides and controls such selective association as well as the insertion or non-insertion of lines and arrows from the annotations to selected points on the chart or screen, such that the analyst enhances the financial information displayed by the charts in the screens presented to the users of the disclosed system and method.

In addition, the analyst may generate new annotations or may edit, copy, or delete previously generated annotations using corresponding commands such as NEW, EDIT, COPY, DELETE, etc., provided through the GUI in a manner known in the art using windows and menu software functions, with such operations performed in the form of commands available through pull-down menus or through predetermined hotkeys or key combinations. Accordingly, FIG. 11 illustrates an input window applet with the heading “Write Text” for generating a new annotation, while FIG. 13 illustrates an input window applet with the heading “Edit Text” for editing a pre-existing annotation; for example, if the annotation “Red & yellow crossover . . . ” had previously existed on the screen of FIG. 13, upon editing, the annotation is overlapped or hidden by the Edit Text window as shown in FIG. 13.

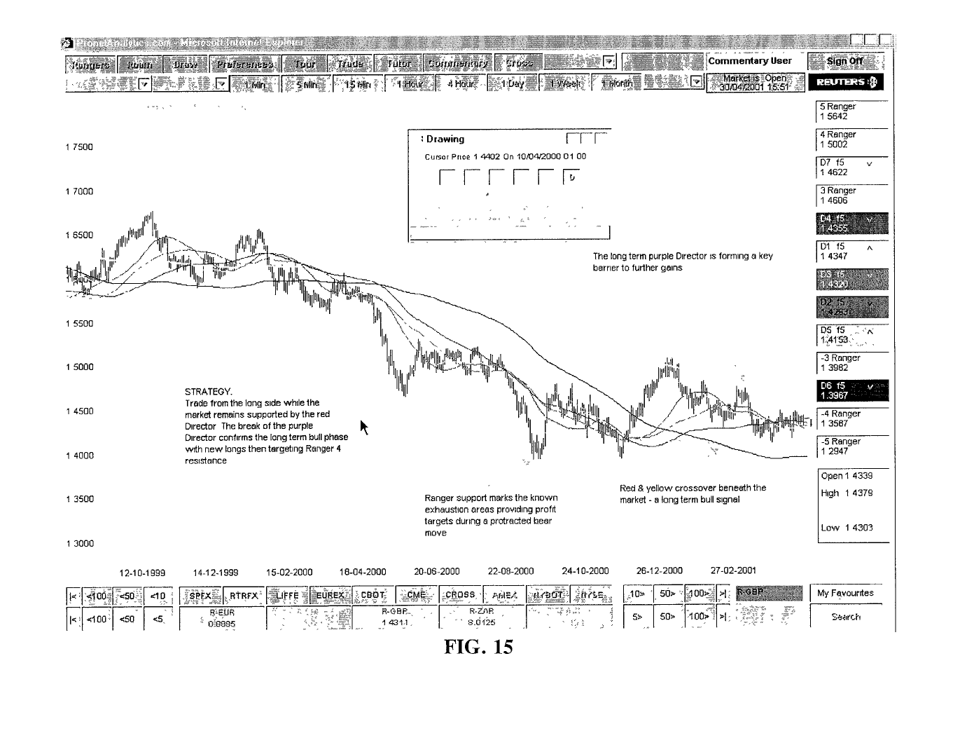

In addition, analysts may input general commentary or other text to be visible on the graph which may not necessarily be associated with specific financial data in the chart. For example, as shown in FIG. 15, an analyst may have entered a strategy commentary such as “STRATEGY: Trade from the long side while the market remains supported by the red Director. The break of the purple Director confirms the long term bull phase with new longs then targeting Ranger 4 resistance.”

In a preferred embodiment, the annotations in FIGS. 10-15 scroll leftward to be removed automatically by the disclosed system and method from being displayed on the screen of users as time passes, such that the annotations’ corresponding anchor points in the chart or grid lines associated with the time index of the horizontal axis scroll leftward and “off” or “out of” the visible screen. However, the user may scroll the screen rightward or increase the time period shown by the screen to encompass an earlier time in the past, such as two months earlier instead of, for example, a default of one month, and so to view earlier financial data and their associated annotations.

In an alternative embodiment, to conserve memory storage, the annotations and commentary may be stripped from the financial data, depending on the time frame of the financial data. For example, commentary may be removed at a preset time, such as midnight each day, for charts having time frames of one hour or less. In another example, time frames of four hours or more may retain their commentary until midnight of a pre-selected day of the week, such as Sunday.

The stripped annotations may be stored separately in their own indexed database in the Sybase or Weblogic servers using, for example, a time index as to what point of time or time period the annotation was associated. In another alternative embodiment, the stripped annotations may be deleted after a predetermined time period after generation, such as six months.

In alternative embodiments, an analyst may insert annotations or commentary which remain fixed on the screen permanently and/or until an analyst removes the inserted annotation, or for a predetermined limited time period. In this embodiment, the fixed annotation does not move leftward, or move at all, and is not removed automatically as time passes. For example, an analyst may cause the display of the phrase “We are in a bull market now” or “Country X is in a recession”, which may be a meta-annotation for the entire set of financial data being displayed in the user screens until, for example, analysts determine that circumstances in the market such as a bull market or recession have changed or are uncertain to make such a pronouncement.

While the invention has been particularly shown and described with reference to a preferred embodiment thereof, it will be understood by those skilled in the art that various changes in form and details may be made therein without departing from the spirit and scope of the invention.

The embodiments of the invention in which an exclusive property or privilege is claimed are defined as follows:

1. A graphical display system comprising:
a server for receiving and processing financial instrument data from at least one financial data feed; and
a client computing device connected to said server, said client computing device including a display for concurrently displaying to a user:
processed financial instrument data for a plurality of financial instruments in graphical form, wherein said processed financial instrument data is processed using predetermined analytic procedures to chart and project the behavior of selected financial instruments;
a multi-media streaming video presentation; and,
interactive communications, wherein the interactive communications are associated with said financial instruments.

2. The graphical display system in accordance with claim 1, wherein said server further comprises means for receiving analyst text inputs.

3. The graphical display system in accordance with claim 2, wherein said text inputs are associated with selected financial instrument data.

4. The graphical display system in accordance with claim 3, wherein said client computing device further concurrently displays said text inputs associated with said financial instrument data.

5. The graphical display system in accordance with claim 1, wherein said at least one financial data feed comprises a plurality of financial data feeds.

6. The graphical display system in accordance with claim 1, wherein said financial instrument data received by said server comprises streamed data and wherein said graphical display of said processed financial instrument data on said client computing device is updated in real time as said streamed data is processed.

7. The graphical display system in accordance with claim 1, wherein said server has a web-based architecture which allows multiple client computing devices to access its data via an internet connection.

8. The graphical display system in accordance with claim 7, wherein said server-comprises an application server and a web server.

9. A graphical display system comprising:
a server for receiving and processing financial instrument data from at least one financial data feed and for receiving analyst text inputs associated with selected financial instrument data; and
a client computing device connected to said server, said client computing device including a display for concurrently displaying to a user:
processed financial instrument data for a plurality of financial instruments in graphical form, wherein said processed financial instrument data is processed using predetermined analytic procedures to chart and project the behavior of selected financial instruments; and,
said text inputs associated with said financial instrument data.

10. The graphical display system in accordance with claim 9, wherein said financial instrument data received by said server comprises streamed data and wherein said graphical display of said processed financial instrument data on said client computing device is updated in real time as said streamed data is processed.

11. The graphical display system in accordance with claim 9, wherein said server has a web-based architecture which allows multiple client computing devices to access its data via an internet connection.

12. A method of receiving, processing and displaying financial information, comprising:
receiving financial instrument data from at least one financial data feed;
processing said financial instrument data using predetermined analytic procedures to create processed financial instrument data which graphically represents the behavior of selected financial instruments;
receiving from a plurality of client computing devices text inputs associated with selected financial instrument data; and,
transmitting to a client computing device for concurrent display a data stream which includes processed financial instrument data in graphical form, interactive communications associated with said financial instruments, and said text inputs associated with selected financial instrument data.
